(19) United States
(12) Patent Application Publication
(10) Pub. No.: US 2010/0327959 A1
(43) Pub. Date: Dec. 30, 2010

(54) HIGH EFFICIENCY CHARGE PUMP

(75) Inventor: Jae-youn LEE, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/797,023

(22) Filed: Jun. 9, 2010

(30) Foreign Application Priority Data
Jun. 24, 2009 (KR) 2009-56540

(51) Int. Cl. G05F 1/10

(52) U.S. Cl. 327/536

(57) ABSTRACT

A charge pump circuit includes a first and second charge pumps. Each of the first and second charge pumps includes a boosting unit to respectively initialize and boost a voltage, a transmission transistor to transmit the boosting voltage to an output node, and a control unit to control the transmission transistor. The charge pump circuit has a higher voltage boosting efficiency and higher power efficiency.

### CROSS-REFERENCE TO RELATED APPLICATIONS

This application claims the benefit of priority from Korean Patent Application No. 10-2009-0056540, filed on Jun. 24, 2009, in the Korean Intellectual Property Office, the disclosure of which is incorporated herein in its entirety by reference.

### BACKGROUND

1. Field of the Invention

The present general inventive concept relates to a method of generating a boosting voltage, and more particularly, to a high efficiency charge pump circuit used in semiconductor integrated circuits.

2. Description of the Related Art

A semiconductor integrated circuit (IC) may include components requiring a high voltage due to its operating characteristics. In the case where a semiconductor IC is used with a device requiring a high operating voltage or a semiconductor IC includes circuits requiring high operating voltages, the semiconductor IC should include a boosting unit to generate a high voltage that is higher than a power voltage of the semiconductor IC. For example, a liquid crystal display (LCD) driver IC (LDI) for driving a thin-film transistor (TFT)-LCD for a mobile device requires a source line driving voltage AVDD, a common electrode driving voltage VCOM, a gamma driving reference voltage GVDD, and LCD on/off voltages VGH and VGL. For example, an LDI for a mobile device should receive an external battery power voltage VCI from about 2.5 V to about 3.0 V, generate a boosted voltage AVDD of about 5.5 V, and generate the voltages stated above by using the boosted voltage AVDD. A charge pump is a boosting unit using the law of conservation of electrical charge in relation to a capacitor. Trends of reducing size and power consumption of a LDI demand a technique to improve voltage boosting efficiency and power efficiency of a charge pump circuit for the miniaturization and integration of a pumping capacitor for a charge pump.

### SUMMARY

The present general inventive concept provides a charge pump with high voltage boosting efficiency and high power efficiency.

Additional aspects and utilities of the present general inventive concept will be set forth in part in the description which follows and, in part, will be obvious from the description, or may be learned by practice of the general inventive concept.

Features and/or utilities of the present general inventive concept may be realized by a charge pump including first and second charge pumps which complementarily perform an initialization operation and a voltage boosting operation in response to a first clock signal and a second clock signal, respectively, and share an output node. Each of the first and second charge pumps includes a boosting unit to either initialize the voltage of a voltage boosting node to a first voltage or boost the voltage of the voltage boosting node to a second voltage in response to the corresponding clock signal, a transmission transistor to transmit the second voltage of the voltage boosting node to the output node, and a control unit to control the gate voltage of the transmission transistor, such that the absolute value of a gate-source voltage of the transmission transistor to turn on the transmission transistor is greater than a power voltage.

The control unit may control the gate voltage of the transmission transistor such that the absolute value of the gate-source voltage of the transmission transistor to turn off the transmission transistor becomes the power input voltage. The boosting unit may include a pumping capacitor, the voltage boosting node may be connected to a first terminal of the pumping capacitor, and the corresponding clock signal may be input to a second terminal of the pumping capacitor. The boosting unit may also include an initialization transistor to transmit the first voltage to the voltage boosting node, and the initialization transistor may be turned on by the second voltage.

The control unit may include a pull-up transistor and a pull-down transistor that are connected in series, the pull-up transistor may be turned on and may output the second voltage during the initialization operation, and the pull-down transistor may be turned on and may output a ground voltage during the voltage boosting operation. The first voltage may be the power input voltage, the initialization transistor and the pull-down transistor may be NMOS-type transistors, and the pull-up transistor may be a PMOS-type transistor. The boosting unit may include an inverter to supply the corresponding clock signal to the second terminal of the pumping capacitor.

The inverter of the first charge pump and the control unit of the second charge pump may output a pull-down voltage and a pull-up voltage in response to first and second control signals, respectively, the inverter of the second charge pump and the control unit of the first charge pump may output a pull-up voltage and a pull-down voltage in response to third and fourth control signals, respectively, the first and second control signals may have different duties, so that their level transition sections do not overlap each other, and the third and fourth control signals may be opposite signals of the first and second control signals, respectively.

The control unit may include a pull-up transistor and a pull-down transistor that are connected in series, the pull-down transistor may be turned on and may output the second voltage during the initialization operation, and the pull-up transistor may be turned on and may output a ground voltage during the voltage boosting operation. The first voltage may be the ground voltage, the initialization transistor and the pull-up transistor may be PMOS-type transistors, and the pull-down transistor may be a NMOS-type transistor.

The boosting unit may further comprise an inverter to supply the corresponding clock signal to a terminal of the pumping capacitor.

The inverter of the first charge pump and the control unit of the second charge pump may output a pull-down voltage and a pull-up voltage in response to first and second control signals, respectively, the inverter of the second charge pump and the control unit of the first charge pump may output a pull-up voltage and a pull-down voltage in response to third and fourth control signals, respectively, the first and second control signals may have different duties, so that their level transition sections do not overlap each other, and the third and fourth control signals may be opposite signals of the first and second control signals, respectively.

Features and/or utilities of the present general inventive concept may also be realized by a charge pump compound circuit including a first charge pump circuit and a second charge pump circuit which is initialized by an output voltage of the first charge pump circuit. Each of the first and second charge pump circuits may include first and second charge pumps which complementarily perform an initialization operation and a voltage boosting operation in response to a first clock signal and a second clock signal, respectively, and share an output node. Each of the first and second charge pumps may include a boosting unit to initialize the voltage of a voltage boosting node to a first voltage and to boost the voltage of the voltage boosting node to a second voltage in response to the corresponding clock signal, a transmission transistor to transmit the second voltage of the voltage boosting node to the output node, and a control unit to control a gate voltage of the transmission transistor such that the absolute value of a gate-source voltage of the transmission transistor for turning on the transmission transistor is greater than a power voltage.

Features and/or utilities of the present general inventive concept may also be realized by an electronic device including at least one high-power component to receive a high-power input signal, at least one low-power component to receive a low-power input signal, a power supply to supply the low-power input signal, and a charge pump circuit to receive the low-power input signal and to output the high-power input signal.

Features and/or utilities of the present general inventive concept may also be realized by a charge pump circuit including first and second charge pumps. Each of the first and second charge pumps may include a boosting unit including a voltage boosting node, the boosting unit to respectively initialize a voltage of the voltage boosting node to a first voltage and boost the voltage of the voltage boosting node to a second voltage having a magnitude greater than the first voltage, and a control unit to control an output of the boosted voltages of the respective voltage boosting nodes of the first and second charge pumps based on an input clock signal. The first charge pump may receive a first input clock signal and the second charge pump may receive a second input clock signal different from the first input clock signal.

The first input clock signal may be the inverse of the second input clock signal.

Each of the first and second charge pumps may include a transmission transistor positioned between the voltage boosting node and a voltage output node, and the control circuit may control the on/off state of the transmission transistor based on the input clock signal.

Each of the first and second charge pumps may include an initialization transistor positioned between the voltage boosting node and a power input supplying power having the first voltage, and the initialization transistor of each of the first and second charge pumps may be turned on/off according to a voltage level of the voltage boosting node of the other of the first and second charge pumps.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a circuit diagram of a positive charge pump according to an embodiment of the present general inventive concept;

FIG. 2 is a circuit diagram of a negative charge pump according to an embodiment of the present general inventive concept;

FIG. 3 is a circuit diagram of a positive charge pump according to an embodiment of the present general inventive concept;

FIG. 4 is a circuit diagram of a negative charge pump according to an embodiment of the present general inventive concept;

FIG. 5 is a timing diagram of control signals (A, B, AB, and BB) to drive a charge pump according to an embodiment of the present general inventive concept;

FIG. 6 is a block diagram of a positive charge pump circuit according to embodiment of the present general inventive concept that are connected in cascade;

FIG. 7 is a block diagram of a negative charge pump circuit according to an embodiment of the present general inventive concept that are connected in cascade; and

FIGS. 8A and 8B illustrate devices including a charge pump circuit according to embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, the present general inventive concept will be described in detail by explaining exemplary embodiments of the invention with reference to the attached drawings. Like reference numerals in the drawings denote like elements.

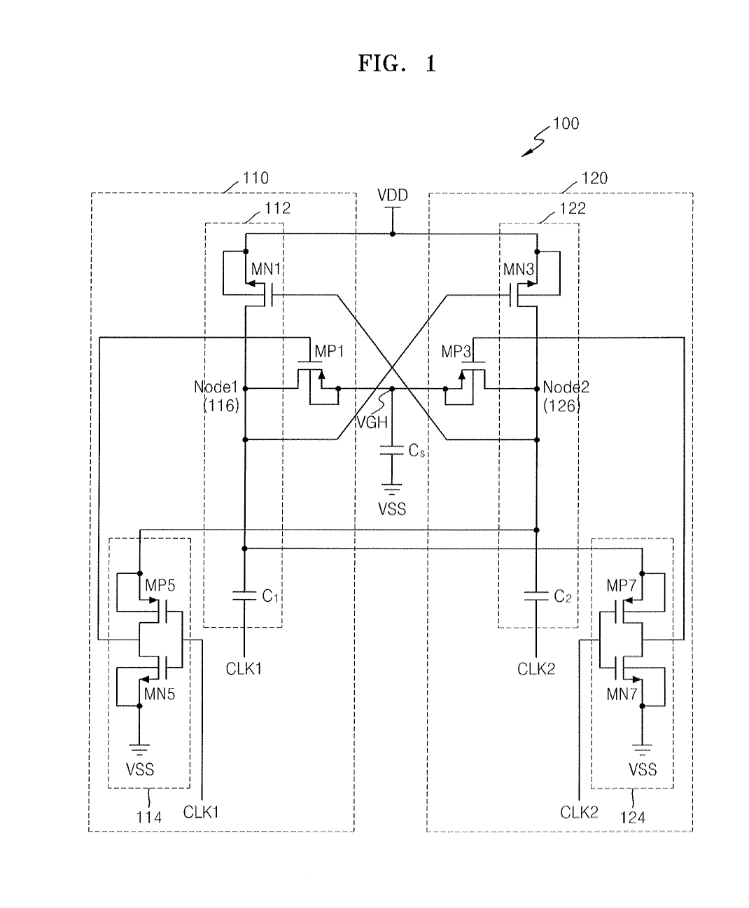

FIG. 1 is a circuit diagram of a positive charge pump 100 according to an embodiment of the present general inventive concept.

Referring to FIG. 1, the positive charge pump circuit 100 includes a first charge pump 110 and a second charge pump 120, which complementarily perform an initialization operation and a voltage boosting operation in response to a first clock signal CLK1 and a second clock signal CLK2, respectively, and share an output node VGH. The first charge pump 110 includes a boosting unit 112, a transmission transistor MP1, and a control unit 114.

The boosting unit 112 initializes the voltage of a first voltage boosting node 116 to a power voltage VDD at the logic low level of a first clock signal CLK1 (initializing operation), and boosts the voltage of the first voltage boosting node 116 to 2VDD at the logic high level of a first clock signal CLK1 (voltage boosting operation). The boosting unit 112 includes an initialization transistor MN1 and a pumping capacitor C1. The initialization transistor MN1 includes a first terminal connected to the power voltage VDD, a second terminal connected to the first voltage boosting node 116, and a gate terminal connected to a second voltage boosting node 126 of the second charge pump 120. The pumping capacitor C1 includes a first terminal that receives a first clock signal CLK1 and a second terminal connected to the first voltage boosting node 116. The transmission transistor MP1 transmits the voltage 2VDD of the first voltage boosting node 116 to the output node VGH.

The second charge pump 120 includes a boosting unit 122, a transmission transistor MP3, and a control unit 124. The boosting unit 122 initializes the voltage of the second voltage boosting node 126 to the power voltage VDD at the logic low level of a second clock signal CLK2 (initializing operation), and boosts the voltage of the second voltage boosting unit 126 to 2VDD at the logic high level of a second clock signal CLK2. The initialization transistor MN3 includes a first terminal connected to the power voltage VDD, a second terminal connected to the second voltage boosting node 126, and a gate terminal connected to a first voltage boosting node 116 of the first charge pump 110. The pumping capacitor C2 includes a first terminal that receives a second clock signal CLK2 and a second terminal connected to the second voltage boosting node 126. The transmission transistor MP3 transmits the voltage 2VDD of the second voltage boosting node 126 to the output node VGH. The phase of a first clock signal CLK1 and the phase of a second clock signal CLK2 are opposite to each other. Therefore, when one of the first charge pump 110 and the second charge pump 120 performs the initializing operation, the other one of the first charge pump 110 and the second charge pump 120 performs the voltage boosting operation.

In particular, if a high-level first clock signal CLK1 is input when the first voltage boosting node 116 is initialized to a power voltage VDD (a second clock signal CLK2 is at the low level), the voltage of the voltage boosting node 116 is positive-boosted from VDD to 2VDD. The voltage 2VDD of the first voltage boosting node 116 turns the initialization transistor MN3 of the second charge pump 120 on and initializes the voltage of the second voltage boosting node 126 to the power voltage VDD. The control unit 114 transmits a ground voltage VSS to the gate terminal of the transmission transistor MP1 in response to a high-level first clock signal CLK1.

As a result, a gate-source voltage Vgs of the PMOS-type transmission transistor MP1 becomes VSS−2VDD=−2VDD and the PMOS-type transmission transistor MP1 is turned on. Meanwhile, the control unit 124 transmits the voltage 2VDD of the second voltage boosting node 126 to the gate terminal of the transmission transistor MP3 in response to a low-level second clock signal CLK2. As a result, a gate-source voltage Vgs of the transmission transistor MP3 becomes 2VDD−VDD=VDD and the PMOS-type transmission transistor MP3 is turned off. Therefore, in the case where a first clock signal CLK1 is high (a second clock signal CLK2 is low), the voltage 2VDD of the first voltage boosting node 116 is transmitted to the output node VGH and a capacitor Cs is charged to 2VDD as the first charge pump 110 performs a positive voltage boosting operation and the second charge pump 120 performs an initialization operation.

In contrast, when a low-level first clock signal CLK1 is input (a second clock signal CLK2 is high), the second voltage boosting node 126 is boosted from VDD to 2VDD in response to a high-level second clock signal CLK2 (voltage boosting operation), and thus the initialization transistor MN1 is turned on. As a result, the voltage of the first voltage boosting node 116 is initialized to VDD (initialization operation).

The control unit 114 transmits the voltage 2VDD of the second voltage boosting node 126 of the second charge pump 120 to the gate terminal of the transmission transistor MP1 in response to a low-level first clock signal CLK1. As a result, the gate-source voltage Vgs of the transmission transistor MP1 becomes 2VDD−VDD=VDD and the PMOS-type transmission transistor MP1 is turned off. Meanwhile, the control unit 124 transmits the ground voltage VSS to the gate terminal of the transmission transistor MP3 in response to a high-level second clock signal CLK2. As a result, the gate-source voltage Vgs of the transmission transistor MP3 becomes VSS−2VDD=—2VDD and the PMOS-type transmission transistor MP3 is turned on. Therefore, in the case where a first clock signal CLK1 is low (a second clock signal CLK2 is high), the voltage 2VDD of the second voltage boosting node 126 is transmitted to the output node VGH and the capacitor Cs is charged to 2VDD as the first charge pump 110 performs an initialization operation and the second charge pump 120 performs a positive voltage boosting operation.

As a result, the positive charge pump 100 outputs boosted voltages 2VDD in both a high level and a low level of the a first clock signal CLK1 (or a second clock signal CLK2) as the first charge pump 110 and the second charge pump 120 complementarily perform an initialization operation and a voltage boosting operation. Furthermore, loss due to a threshold voltage at the time of transmitting the boosted voltage of the first voltage boosting node 116 or the second voltage boosting node 126 to the output node VGH is eliminated with the PMOS-type transmission transistors MP1 and MP3. Furthermore, the absolute value of the gate-source voltage Vgs to turn on the PMOS-type transmission transistors MP1 and MP3 becomes 2VDD, which is greater than the power voltage VDD, without using a level shifter. Consequently, power efficiency and voltage boosting efficiency may be improved as on-resistances of the PMOS-type transmission transistors MP1 and MP3 decrease.

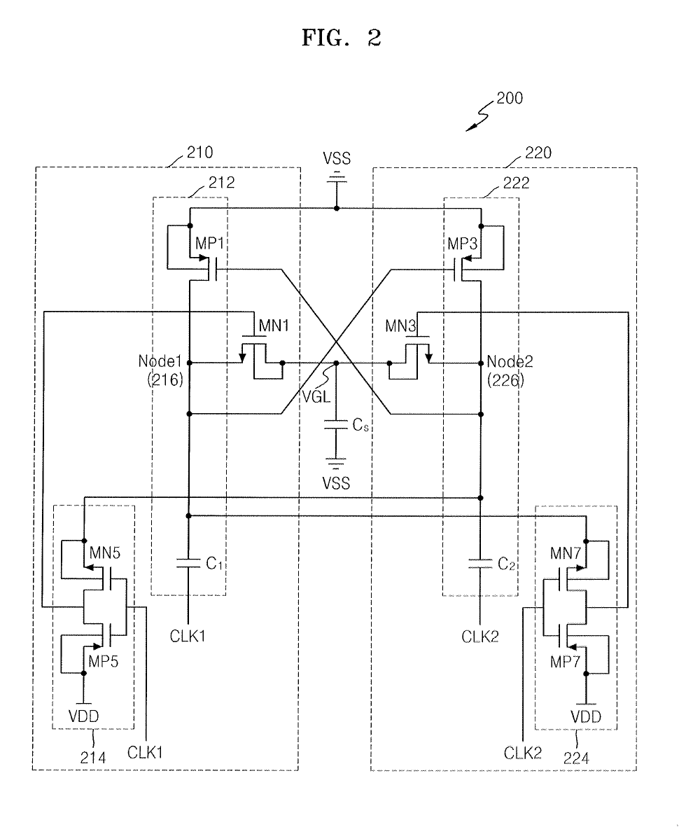

FIG. 2 is a circuit diagram of a negative charge pump circuit 200 according to an embodiment of the present general inventive concept.

Referring to FIG. 2, the negative charge pump circuit 200 may include a first charge pump 210 and a second charge pump 220, which complementarily perform an initialization operation and a voltage boosting operation in response to a first clock signal CLK1 and a second clock signal CLK2, respectively and share an output node VGL.

The first charge pump 210 includes a boosting unit 212, a transmission transistor MN1, and a control unit 214.

The boosting unit 212 initializes the voltage of a first voltage boosting node 216 to a ground voltage VSS at the logic high level of a first clock signal CLK1 (initializing operation), and negative-boosts the voltage of the first voltage boosting node 216 to −VDD at the logic low level of a first clock signal CLK1 (voltage boosting operation). The boosting unit 212 includes an initialization transistor MP1 and a pumping capacitor C1. The initialization transistor MP1 includes a first terminal connected to the ground voltage VSS, a second terminal connected to the first voltage boosting node 216, and a gate terminal connected to a second voltage boosting node 226 of the second charge pump 220. The pumping capacitor C1 includes a first terminal that receives a first clock signal CLK1 and a second terminal connected to the first voltage boosting node 216. The transmission transistor MN1 transmits the voltage −VDD of the first voltage boosting node 216 to the output node VGL.

The second charge pump 220 includes a boosting unit 222, a transmission transistor MN3, and a control unit 224. The boosting unit 222 initializes the voltage of the second voltage boosting node 226 to the ground voltage VSS at the logic high level of a second clock signal CLK2 (initializing operation), and negative-boosts the voltage of the second voltage boosting unit 226 to −VDD at the logic low level of a second clock signal CLK2 (voltage boosting operation). The boosting unit 222 includes an initialization transistor MP3 and a pumping capacitor C2. The initialization transistor MP3 includes a first terminal connected to the ground voltage VSS, a second terminal connected to the second voltage boosting node 226, and a gate terminal connected to a first voltage boosting node 216 of the first charge pump 210. The pumping capacitor C2 includes a first terminal that receives a second clock signal CLK2 and a second terminal connected to the second voltage boosting node 226. The transmission transistor MN3 transmits the voltage −VDD of the second voltage boosting node 226 to the output node VGL. The phase of a first clock signal CLK1 and the phase of a second clock signal CLK2 are opposite to each other. Therefore, when one of the first charge pump 210 and the second charge pump 220 performs the initializing operation, the other one of the first charge pump 210 and the second charge pump 220 performs the voltage boosting operation.

In particular, if a low-level first clock signal CLK1 is input (a second clock signal CLK2 is high) when the first voltage boosting node 216 is initialized to the ground voltage VSS, the voltage of the first voltage boosting node 216 is negative-boosted from VSS to −VDD. Therefore, the voltage −VDD of the first voltage boosting node 216 turns on the initialization transistor MP3 and initializes the voltage of the second voltage boosting node 226 to the ground voltage VSS. The control unit 214 transmits a power voltage VDD to the gate terminal of the transmission transistor MN1 in response to a low-level first clock signal CLK1. As a result, a gate-source voltage Vgs of the transmission transistor MN1 becomes VDD−(−VDD)=2VDD and the NMOS-type transmission transistor MN1 is turned on. Meanwhile, the control unit 224 transmits the voltage −VDD of the first voltage boosting node 216 of the first charge pump 210 to the gate terminal of the transmission transistor MN3 in response to a high-level second clock signal CLK2. As a result, a gate-source voltage Vgs of the NMOS-type transmission transistor MN3 becomes −VDD−VSS=−VDD and the transmission transistor MN3 is turned off. Therefore, in the case where a first clock signal CLK1 is low (a second clock signal CLK2 is high), the voltage −VDD of the first voltage boosting node 216 is transmitted to the output node VGL and a capacitor Cs is charged to −VDD as the first charge pump 210 performs a negative voltage boosting operation and the second charge pump 220 performs an initialization operation.

In contrast, when a high-level first clock signal CLK1 is input (a second clock signal CLK2 is low), the voltage of the voltage boosting node 226 is negative-boosted from the ground voltage VSS to −VDD by a low-level second clock signal CLK2, and thus the initialization transistor MP1 is turned on. As a result, the voltage of the first voltage boosting node 216 is initialized to the ground voltage VSS. The control unit 214 transmits the voltage −VDD of the second voltage boosting node 226 to the gate terminal of the transmission transistor MN1 in response to a high-level first clock signal CLK1. As a result, the gate-source voltage Vgs of the transmission transistor MN1 becomes −VDD−VSS=−VDD, and the NMOS-type transmission transistor MN1 is turned off. Meanwhile, the control unit 224 transmits the power voltage VDD to the gate terminal of the transmission transistor MN3 in response to a low-level second clock signal CLK2. As a result, the gate-source voltage Vgs of the transmission transistor MN3 becomes VDD−(−VDD)=2VDD, and the NMOS-type transmission transistor MN3 is turned on. Therefore, in the case where a first clock signal CLK1 is high (a second clock signal CLK2 is low), the voltage −VDD of the second voltage boosting node 226 is transmitted to the output node VGL and the capacitor Cs is charged to −VDD as the first charge pump 210 performs an initialization operation and the second charge pump 220 performs a negative voltage boosting operation.

As a result, the negative charge pump circuit 200 outputs negative-boosted voltages −VDD in both a high level and a low level of a first clock signal CLK1 (or a second clock signal CLK2) as the first charge pump 210 and the second charge pump 220 complementarily perform an initialization operation and a voltage boosting operation. Furthermore, loss due to a threshold voltage at the time of transmitting the boosted voltage of the first voltage boosting node 116 or the second voltage boosting node 126 to the output node VGL is eliminated by using the NMOS-type transmission transistors MN1 and MN3. Furthermore, the absolute value of the gate-source voltage Vgs to turn on the NMOS-type transmission transistors MN1 and MN3 becomes 2VDD, which is greater than a power voltage VDD, without using a level shifter. Consequently, power efficiency and voltage boosting efficiency may be improved as on-resistances of the NMOS-type transmission transistors MN1 and MN3 decrease.

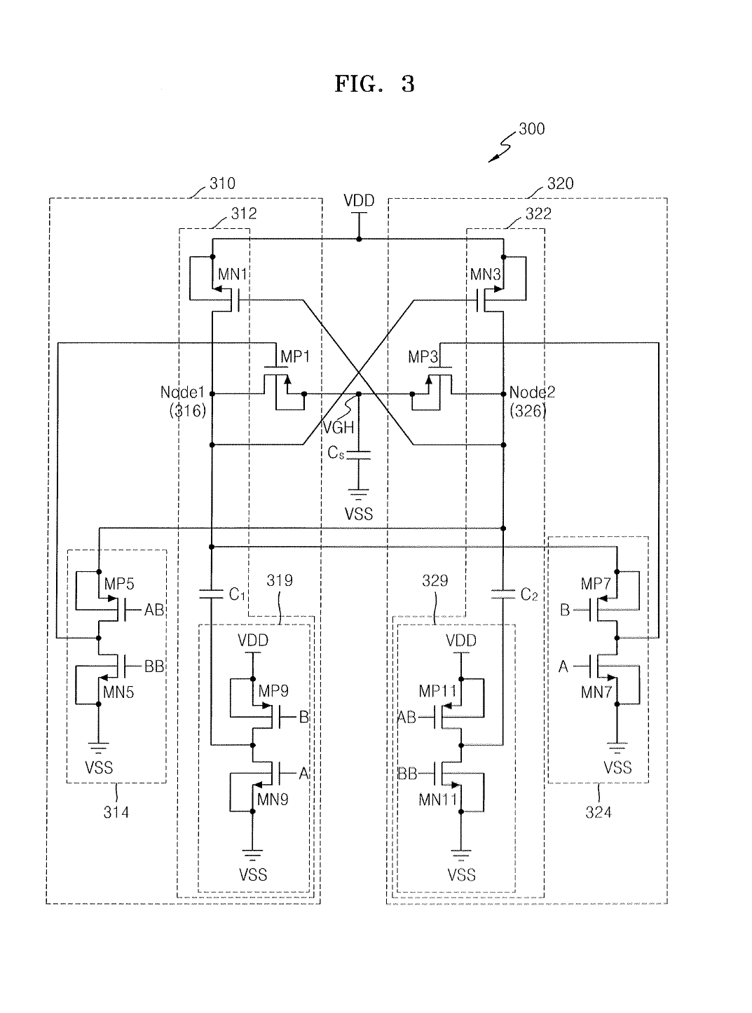

FIG. 3 is a circuit diagram of a positive charge pump circuit 300 according to an embodiment of the present general inventive concept.

Referring to FIG. 3, the positive charge pump circuit 300 includes inverters 319 and 329 respectively to supply a first clock signal CLK1 and a second clock signal CLK2 in the embodiment shown in FIG. 1, as compared to the positive charge pump 100 shown in FIG. 1. In FIG. 3, PMOS-type transistors MP9 and MP11 and NMOS-type transistors MN9 and MN11, which respectively constitute the inverters 319 and 329, may be respectively controlled by control signals A and B and control signals AA and BB to prevent switching current due to simultaneous turn-ons of the PMOS-type transistors MP9 and MP11 and the NMOS-type transistors MN9 and MN11, wherein the control signals A and B and the control signals AA and BB have different duties and their level transition sections do not overlap each other. Furthermore, PMOS-type transistors MP5 and MP7 and NMOS-type transistors MN5 and MN7, which respectively constitute control unit 314 and 324, may be respectively controlled by control signals A and B and control signals AA and BB to prevent switching current due to simultaneous turn-ons of the PMOS-type transistors MP5 and MP7 and the NMOS-type transistors MN5 and MN7, wherein the control signals A and B and the control signals AA and BB have different duties and their level transition sections do not overlap each other.

The positive charge pump circuit 300 includes first and second charge pumps 310 and 320. The first charge pump 310 includes a control unit 314 and a boosting unit 312 that may include a node 316 and the inverter 319. The second charge pump 320 includes a control unit 324 and a boosting unit 322 that may include a node 326 and the inverter 329. With the exception of the inverters 319 and 329, the features of the positive charge pump circuit 300 are similar to those of the positive charge pump circuit 100 shown in FIG. 1, and thus detailed descriptions thereof will be omitted.

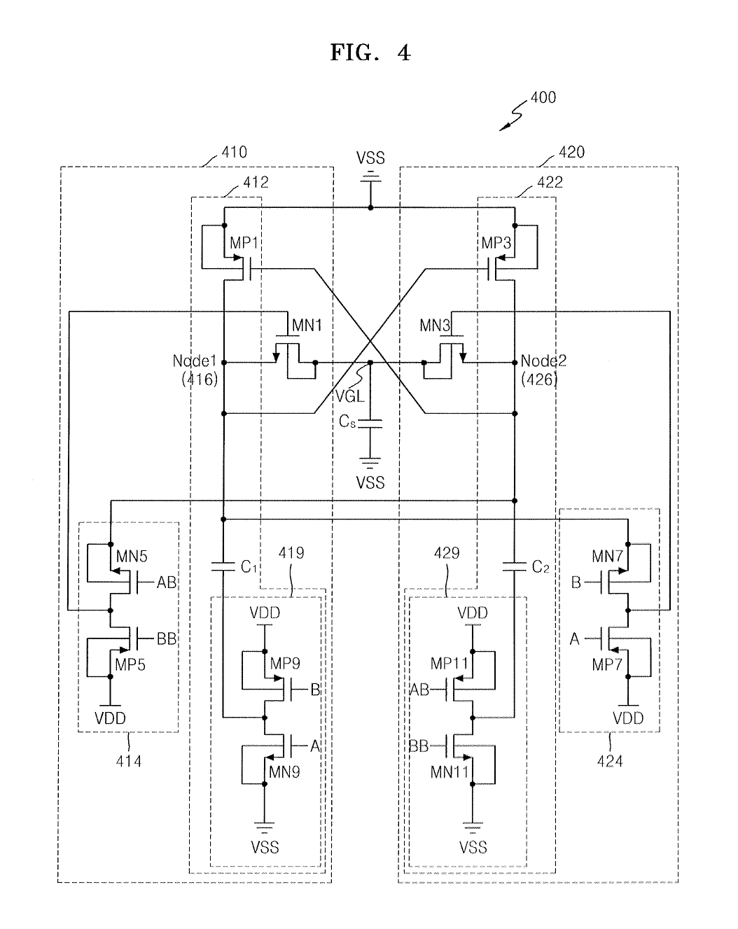

FIG. 4 is a circuit diagram of a negative charge pump circuit 400 according to an embodiment of the inventive concept.

Referring to FIG. 4, the negative charge pump circuit 400 may further include inverters 419 and 429 respectively to supply a first clock signal CLK1 and a second clock signal CLK2 in the embodiment shown in FIG. 2, as compared to the negative charge pump circuit 200 shown in FIG. 2. The PMOS-type transistors MP9 and MP11 and the NMOS-type transistors MN9 and MN11, which respectively constitute the inverters 419 and 429, may be respectively controlled by control signals A and B and control signals AB and BB to prevent switching current due to simultaneous turn-ons of the PMOS-type transistors MP9 and MP11 and the NMOS-type transistors MN9 and MN11, wherein the control signals A and B and the control signals AB and BB have different duties and their level transition sections do not overlap each other. Furthermore, the PMOS-type transistors MP5 and MP7 and the NMOS-type transistors MN5 and MN7, which respectively constitute control unit 414 and 424, may be respectively controlled by control signals A and B and control signals AB and BB to prevent switching current due to simultaneous turn-ons of the PMOS-type transistors MP5 and MP7 and the NMOS-type transistors MN5 and MN7, wherein the control signals A and B and the control signals AB and BB have different duties and their level transition sections do not overlap each other.

The negative charge pump circuit 400 includes first and second charge pumps 410 and 420. The first charge pump 410 includes a control unit 414 and a boosting unit 412 that may include a node 416 and the inverter 419. The second charge pump 420 includes a control unit 424 and a boosting unit 422 that may include a node 426 and the inverter 429. With the exception of the inverters 419 and 429, the features of the negative charge pump circuit 400 are similar to those of the negative charge pump circuit 200 shown in FIG. 2, and thus detailed descriptions thereof will be omitted.

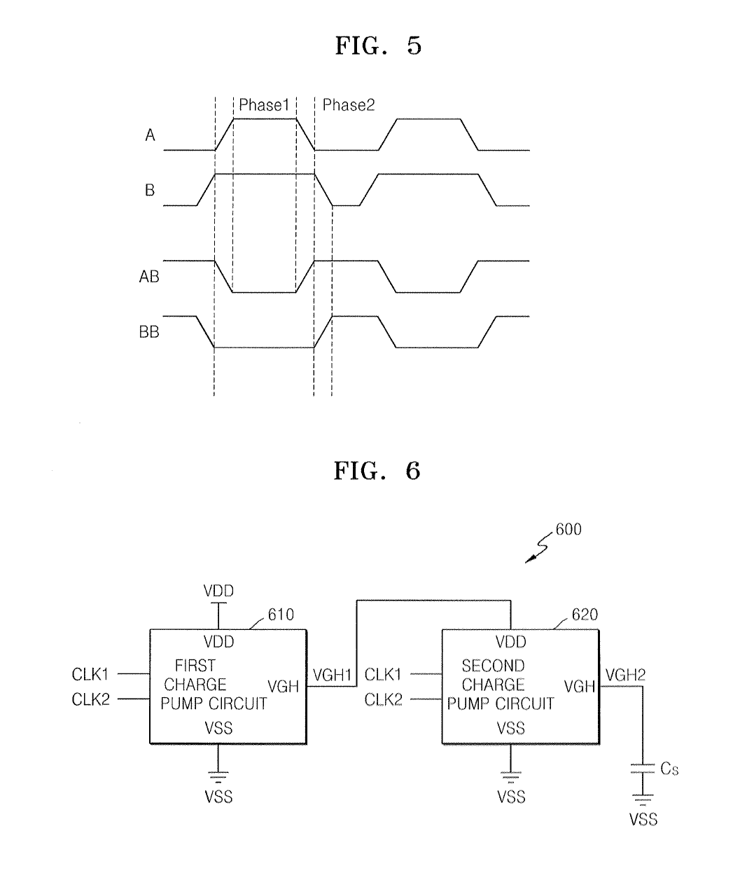

FIG. 5 is a timing diagram of control signals (A, B, AB, and BB) to drive a charge pump according to an embodiment of the present general inventive concept.

Referring to FIG. 5, the control signals A and B (control signal AB is the opposite of control signal A, whereas control signal BB is the opposite of control signal B) may prevent switching current due to simultaneous turn-on of a PMOS transistor and an NMOS transistor, which constitute an inverter, wherein the control signals A and B have different duties and their level transition sections do not overlap each other.

FIG. 6 is a block diagram of a compound positive charge pump circuit 600 according to an embodiment of the present general inventive concept including two charge pump circuits 610 and 620 that are connected in cascade.

Referring to FIG. 6, the output of a first charge pump circuit 610 may be used as the initialization voltage of a second charge pump circuit 620. In other words, a compound charge pump circuit 600 may be formed by connecting an output of a first charge pump circuit 610 to an input of a second charge pump circuit 620. As illustrated in FIGS. 1 and 3, the charge pump circuits 610 and 620 may each include two charge pumps corresponding to the charge pumps 110 and 120 to output a continuous boosted voltage.

In particular, the first charge pump circuit 610 may be initialized to a power voltage VDD, and may output a boosted voltage 2VDD by positive-boosting the initialization voltage VDD. Meanwhile, the second charge pump circuit 620 is initialized to the output voltage 2VDD of the first charge pump circuit 610, and may output a voltage 3VDD by positive-boosting the initialization voltage 2VDD as much as VDD, and thus a capacitor Cs may be charged to 3VDD. Therefore, a boosted voltage, which is three times greater than a power voltage VDD, may be obtained by connecting two positive charge pumps in cascade form according to embodiments of the present general inventive concept. Although not shown in FIG. 6, a positive-boosted voltage 4VDD may be obtained by connecting three positive charge pumps in cascade form, and so on.

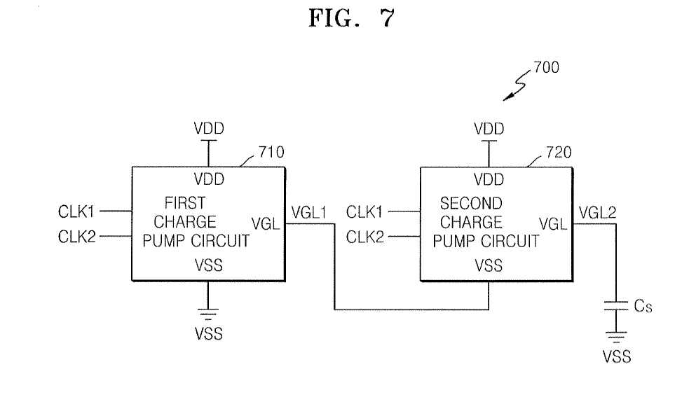

FIG. 7 is a block diagram of a compound negative charge pump circuit 700 according to an embodiment of the present general inventive concept including two charge pump circuits 710 and 720 that are connected in cascade.

Referring to FIG. 7, the output of a first charge pump circuit 710 may be used as the initialization voltage of a second charge pump circuit 720. In particular, the first charge pump circuit 710 may be initialized to a ground voltage VSS, and may output a voltage −VDD by negative-boosting the initialization voltage VSS as much as VDD. Meanwhile, the second charge pump circuit 720 is initialized to the output voltage −VDD of the first charge pump circuit 710, and may output a voltage −2VDD by negative-boosting the initialization voltage −VDD as much as −VDD, and thus a capacitor Cs may be charged to −2VDD. Therefore, a boosted voltage, which is twice as great as the negative voltage of a power voltage VDD, may be obtained by connecting two negative charge pumps in cascade form according to embodiments of the inventive concept. Although not shown in FIG. 7, a negative-boosted voltage −3VDD may be obtained by connecting three negative charge pumps in cascade form, and so on.

While a compound charge pump circuit having two charge pump circuits connected in cascade form according to embodiments of the present general inventive concept have been described above with reference to FIGS. 6 and 7, a number of charge pump circuits able to be connected in cascade form is not limited thereto. In other words, a compound charge pump circuit having any number of charge pump circuits connected in cascade form may be embodied by using the output voltage of a previous charge pump circuit as the initialization voltage of a next charge pump circuit, and thus a voltage boosted to a desired level may be easily obtained.

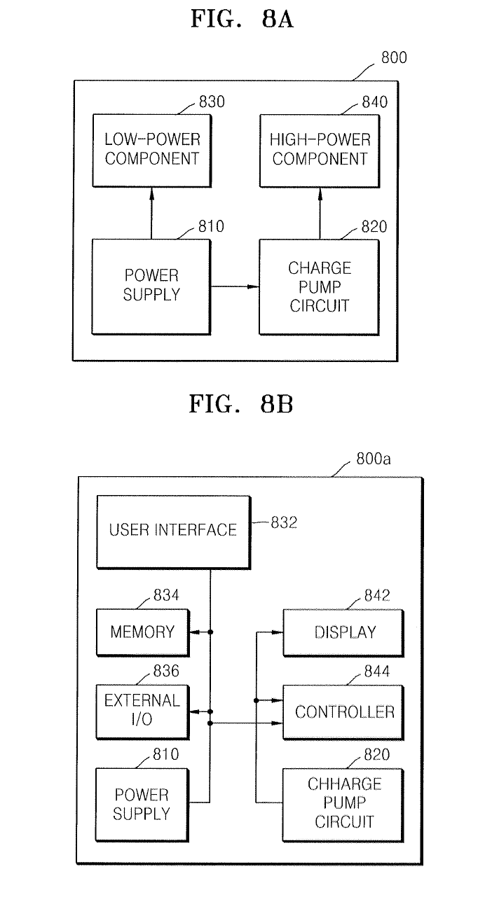

FIG. 8A illustrates a device 800 including a charge pump circuit 820 according to an embodiment of the present general inventive concept. The charge pump circuit 820 may be similar to the positive charge pump circuit 100 illustrated in FIG. 1, the negative charge pump circuit 200 illustrated in FIG. 2, or one of the charge pump circuits 300 or 400 illustrated in FIGS. 3 and 4, or one of the compound charge pump circuits 600 or 700 illustrated in FIGS. 6 and 7, for example.

The device 800 may include a power supply 810. The power supply 810 may include a battery, an external power input, or any other type of power generating input. The power supply 810 outputs at least one low voltage to a low power component 830 and to the charge pump circuit 820. The charge pump circuit 820 generates a second voltage having a greater voltage than the voltage output by the power supply 810. The voltage output by the charge pump circuit 820 may be a negative voltage having a magnitude greater than the magnitude of the voltage output from the power supply 810, or it may be a positive voltage. The charge pump circuit 820 may be connected to one or more high-power components 840 to supply the higher output voltage to the high-power components.

FIG. 8B illustrates an example of a device 800a, such as a portable computing device, cell phone, PDA, or other mobile device. The device 800a includes a user interface 832 to receive input from a user, a memory 834 to store data, an external I/O 836 to communicate with external devices, a display 842 to display images and/or data to a user, and a controller 844 to control operation of the functional units of the device 800a.

In the embodiment of FIG. 8B, the user interface 832, the memory 834, and the external I/O 836 receive power from the power supply 810. In other words, the user interface 832, the memory 834, and the external I/O 836 require only a low-power input. The display 842 receives power from the charge pump circuit 820. In other words, the display 842 requires a high-power or high-voltage input. The controller 844 may receive power from each of the power supply 810 and the charge pump circuit 820, either respectively or simultaneously. For example, if the device 800a has a full-power mode and a low-power mode, the controller 844 may switch between receiving power from the charge pump circuit 820 and the power supply 810, respectively.

Although FIG. 8B illustrates examples of high and low-power functional units, any of the illustrated functional units may receive any level of power, depending on a design of the device 800a. In addition, any functional unit may receive multiple sources of power from the power supply 810 and the charge pump circuit 820, and may switch between high- and low-power operation modes based on the power level received. In addition, different and/or additional functional units may be included in the device 800a. The device 800a may include additional charge pump circuits 820 so that different components may receive varying degrees of voltages. For example, a first component may receive a low power from the power supply 810, a second component may receive a medium power from a first charge pump circuit 820, and a third component may receive a high-power from a third charge pump circuit (not shown).

While the present general inventive concept has been particularly shown and described with reference to exemplary embodiments thereof, it will be understood that various changes in form and details may be made therein without departing from the spirit and scope of the following claims.

What is claimed is:

1. A charge pump circuit comprising:
first and second charge pumps which complementarily perform an initialization operation and a voltage boosting operation in response to a first clock signal and a second clock signal, respectively, and share an output node,
wherein each of the first and second charge pumps comprises:
a boosting unit to respectively initialize the voltage of a voltage boosting node to a first voltage and boost the voltage of the voltage boosting node to a second voltage in response to the corresponding clock signal;
a transmission transistor to transmit the second voltage of the voltage boosting node to the output node; and
a control unit to control the gate voltage of the transmission transistor, such that the absolute value of a gate-source voltage of the transmission transistor to turn on the transmission transistor is greater than a power input voltage.

2. The charge pump circuit of claim 1, wherein the control unit controls the gate voltage of the transmission transistor, such that the absolute value of the gate-source voltage of the transmission transistor to turn off the transmission transistor becomes the power input voltage.

3. The charge pump circuit of claim 2, wherein the boosting unit comprises:
a pumping capacitor, wherein the voltage boosting node is connected to a first terminal of the pumping capacitor, and the corresponding clock signal is input to a second terminal of the pumping capacitor; and
an initialization transistor to transmit the first voltage to the voltage boosting node,
wherein the initialization transistor is turned on by the second voltage.

4. The charge pump circuit of claim 3, wherein the control unit comprises a pull-up transistor and a pull-down transistor that are connected in series,
wherein the pull-up transistor is turned on and outputs the second voltage during the initialization operation, and
the pull-down transistor is turned on and outputs a ground voltage during the voltage boosting operation.

5. The charge pump circuit of claim 4, wherein the first voltage is the power input voltage,
the initialization transistor and the pull-down transistor are NMOS-type transistors, and
the pull-up transistor is a PMOS-type transistor.

6. The charge pump circuit of claim 4, wherein the boosting unit further comprises an inverter to supply the corresponding clock signal to the second terminal of the pumping capacitor.

7. The charge pump circuit of claim 6, wherein the inverter of the first charge pump and the control unit of the second charge pump output a pull-down voltage and a pull-up voltage in response to first and second control signals, respectively,
the inverter of the second charge pump and the control unit of the first charge pump output a pull-up voltage and a pull-down voltage in response to third and fourth control signals, respectively,
the first and second control signals have different duties, so that their level transition sections do not overlap each other, and
the third and fourth control signals are opposite signals of the first and second control signals, respectively.

8. The charge pump circuit of claim 3, wherein the control unit comprises a pull-up transistor and a pull-down transistor that are connected in series,
the pull-down transistor is turned on and outputs the second voltage during the initialization operation, and
the pull-up transistor is turned on and outputs a ground voltage during the voltage boosting operation.

9. The charge pump circuit of claim 8, wherein the first voltage is the ground voltage,
the initialization transistor and the pull-up transistor are PMOS-type transistors, and
the pull-down transistor is a NMOS-type transistor.

10. The charge pump circuit of claim 8, wherein the boosting unit further comprises an inverter to supply the corresponding clock signal to a terminal of the pumping capacitor.

11. The charge pump circuit of claim 9, wherein the inverter of the first charge pump and the control unit of the second charge pump output a pull-down voltage and a pull-up voltage in response to first and second control signals, respectively,
the inverter of the second charge pump and the control unit of the first charge pump output a pull-up voltage and a pull-down voltage in response to third and fourth control signals, respectively,
the first and second control signals have different duties, so that their level transition sections do not overlap each other, and
the third and fourth control signals are opposite signals of the first and second control signals, respectively.

12. A charge pump compound circuit comprising:
a first charge pump circuit; and
a second charge pump circuit, which is initialized by an output voltage of the first charge pump circuit,
wherein each of the first and second charge pump circuits comprises first and second charge pumps which complementarily perform an initialization operation and a voltage boosting operation in response to a first clock signal and a second clock signal, respectively, and share an output node,
each of the first and second charge pumps comprises:
a boosting unit to initialize the voltage of a voltage boosting node to a first voltage and to boost the voltage of the voltage boosting node to a second voltage in response to the corresponding clock signal;
a transmission transistor to transmit the second voltage of the voltage boosting node to the output node; and
a control unit to control a gate voltage of the transmission transistor, such that the absolute value of a gate-source voltage of the transmission transistor to turn on the transmission transistor is greater than a power voltage.

13. An electronic device, comprising:
at least one high-power component to receive a high-power input signal;
at least one low-power component to receive a low-power input signal;
a power supply to supply the low-power input signal; and
a charge pump circuit to receive the low-power input signal and to output the high-power input signal,
wherein the charge pump circuit comprises:
first and second charge pumps which complementarily perform an initialization operation and a voltage boosting operation in response to a first clock signal and a second clock signal, respectively, and share an output node,
wherein each of the first and second charge pumps comprises:
a boosting unit to respectively initialize a voltage of a voltage boosting node to a first voltage and boost the voltage of the voltage boosting node to a second voltage in response to the corresponding clock signal;
a transmission transistor to transmit the second voltage of the voltage boosting node to the output node; and
a control unit to control the gate voltage of the transmission transistor, such that the absolute value of a gate-source voltage of the transmission transistor to turn on the transmission transistor is greater than a power input voltage.

14. A charge pump circuit including first and second charge pumps, each of the first and second charge pumps comprising:
a boosting unit including a voltage boosting node, the boosting unit to respectively initialize a voltage of the voltage boosting node to a first voltage and boost the voltage of the voltage boosting node to a second voltage having a magnitude greater than the first voltage; and
a control unit to control an output of the boosted voltages of the respective voltage boosting nodes of the first and second charge pumps based on an input clock signal,
wherein the first charge pump receives a first input clock signal and the second charge pump receives a second input clock signal different from the first input clock signal.

15. The charge pump circuit according to claim 14, wherein the first input clock signal is the inverse of the second input clock signal.

16. The charge pump circuit according to claim 14, wherein each of the first and second charge pumps includes a transmission transistor positioned between the voltage boosting node and a voltage output node, and
the control unit controls the on/off state of the transmission transistor based on the input clock signal.

17. The charge pump circuit according to claim 14, wherein each of the first and second charge pumps includes an initialization transistor positioned between the voltage boosting node and a power input supplying power having the first voltage, and
the initialization transistor of each of the first and second charge pumps is turned on/off according to a voltage level of the voltage boosting node of the other of the first and second charge pumps.
